(19) United States
(12) Patent Application Publication
(10) Pub. No.: US 2012/0209636 A1
(43) Pub. Date: Aug. 16, 2012

(54) SYSTEM AND METHOD FOR FACILITATING AND ARRANGING AIR TRAVEL

(75) Inventors: Susan Leigh SLOAN, Sherman Oaks, CA (US); Laurence Helene RABE, Sherman Oaks, CA (US); Michael David AMADO, Los Angeles, CA (US)

(73) Assignee: VOLJET, Sherman Oaks, CA (US)

(21) Appl. No.: 13/026,890

(22) Filed: Feb. 14, 2011

(51) Int. Cl. G06Q 10/00; G06Q 40/00

(52) U.S. Cl. 705/5; 705/40

(57) ABSTRACT

A system to facilitate group travel on non-commercial aircraft is provided having an aircraft operator database on an electronic medium that can have a listing of registered, independent, and non-commercial aircraft; the aircraft operator database can further have a registry of non-commercial aircraft available to accept a group for an identified trip segment; a grouping service can be provided having access to the aircraft operator database via a computer network that can provide formation of the group to travel and communicate the group to the aircraft operator; and the grouping service can transmit a group acceptance of the group by the aircraft operator.

### FIELD

The present system and methods generally relate to scheduling air-travel, and specifically to facilitating air-travel with private (i.e., non-commercial) and/or commercial aircraft operators.

### BACKGROUND

Premium air travel currently provides few options for convenient, efficient, and cost effective travel outside of the commercial airline industry, even though privately (i.e., non-commercially) owned aircraft are under-utilized. Owning and maintaining an aircraft is prohibitively expensive for many individuals and businesses. When in use, private aircraft typically have minimal passenger loads or even no passengers at all. Nevertheless, premium air travel on private aircraft remains desirable. Attempts to meet this desire can include systems to facilitate air travel using excess capacity on a private aircraft, or even sharing or chartering a private aircraft. Unfortunately, these systems can often include time consuming negotiation with business or private jet operators/brokers, substantial upfront charges, and/or excessively high overall cost.

Chartering a private jet is not always a practical solution for premium air travel due to its inconsistent service and excessive pricing. The current business jet charter market often operates on an outdated business model focused on an existing captive market and generally isolated from the public. For example, a traditional business jet charter can set fees based on a full round-trip flight for an aircraft, even if only one passenger is aboard and may only need to travel one-way. Other premium travel options, such as fractional aircraft ownership and pre-paid hourly jet cards, have also attempted to address these concerns, but still the price of these services is out-of-reach for many who desire these services.

One solution could be to base private aircraft travel on a point-to-point and per passenger model. However, this model can still be problematic in that these systems often provide only “quotes” on the flights requested. Other companies have attempted to address this business problem through brokerage arrangements. These arrangements fail to appeal to the premium traveling public due to costs associated with either the chartering a private jet on an individual basis or as a result of the number of variables required for agreement and the time consumed in the negotiations between multiple prospective travelers.

Accordingly, while the industry has attempted to provide more satisfactory and cost effective premium travel options, further improvements are possible and desired.

### SUMMARY

Accordingly, provided herein are embodiments that relate to air-travel, and specifically to facilitating and arranging air-travel with private (i.e., non-commercial) and/or commercial aircraft operators.

In one preferred embodiment, a system to facilitate group travel on non-commercial aircraft is provided having an aircraft operator database on an electronic medium that can have a listing of registered, independent, and non-commercial aircraft; the aircraft operator database can further have a registry of non-commercial aircraft available to accept a group for an identified trip segment; a grouping service can be provided having access to the aircraft operator database via a computer network that can provide formation of the group to travel and communicate the group to the aircraft operator; and the grouping service can transmit a group acceptance of the group by the aircraft operator.

Optionally, the system can include collection of payment from the group and transfer of payment to the aircraft operator. In some embodiments the formation of a group can close upon identification of a predetermined minimum number of travelers on an identified trip segment. The closed group can be transmitted to the aircraft operator automatically upon closure. Optionally, the group can be transmitted to the aircraft operator upon a request of an aircraft operator and the grouping service having identified at least one traveler for the at least one identified trip segment.

In some embodiments, the identified trip segment information can include airport of origin and destination, space availability, and an approximation of a departure and arrival time within a predetermined time variance.

In other embodiments, the reservation service can connect to a commercial carrier upon request by a traveler either when no availability is found in the aircraft operator database for a desired travel segment or upon request by the traveler. Also, the grouping service can be configured to close a group, accept payment from travelers within the group, and transmit the group to the aircraft operator.

Other features will become more apparent to persons having ordinary skill in the art to which the package pertains and from the following description and claims.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is an exemplary illustration of the initiation of one embodiment of present system for travel purchase.

FIG. 2 is an exemplary illustration of the continuation of one embodiment of present system for travel purchase from FIG. 1.

FIG. 3 is an exemplary illustration of the continuation of one embodiment of present system for travel purchase from FIG. 2.

FIG. 4 is an exemplary illustration of the continuation of one embodiment of present system for travel purchase from FIG. 2.

FIG. 5 is an exemplary illustration of the continuation of one embodiment of present system for travel purchase from FIG. 2.

FIG. 6 is s an exemplary illustration of the continuation of one embodiment of present system for travel purchase from FIG. 4.

FIG. 7 is an exemplary illustration of the continuation of one embodiment of present system for travel purchase from FIG. 5.

FIG. 8 is an exemplary illustration of the continuation of one embodiment of present system for travel purchase from FIG. 6.

FIG. 9 is an exemplary illustration of the continuation of one embodiment of present system for travel purchase from FIG. 8.

FIG. 10 is an exemplary illustration of the continuation of one embodiment of present system for travel purchase from FIG. 9.

FIG. 11 is an exemplary illustration of the continuation of one embodiment of present system for travel purchase from FIG. 1.

FIG. 12 is an exemplary illustration of the continuation of one embodiment of present system for travel purchase from FIG. 11.

FIG. 13 is an exemplary illustration of the continuation of one embodiment of present system for travel purchase from FIG. 11.

FIG. 14 is an exemplary illustration of the continuation of one embodiment of present system for travel purchase from FIG. 13.

FIG. 15 is an exemplary illustration of the continuation of one embodiment of present system for travel purchase from FIG. 13.

FIG. 16 is an exemplary illustration of the continuation of one embodiment of present system for travel purchase from FIG. 15.

FIG. 17 is an exemplary illustration of the continuation of one embodiment of present system for travel purchase from FIG. 10.

FIG. 18 illustrates a symbol legend for the system illustrated in FIGS. 1-17 of one embodiment of present system for travel purchase.

FIG. 19 is an exemplary illustration of a system component block diagram according to one embodiment of present system for travel purchase.

FIG. 20 is an exemplary illustration of a screen shot of a search query for one embodiment of present system for travel purchase.

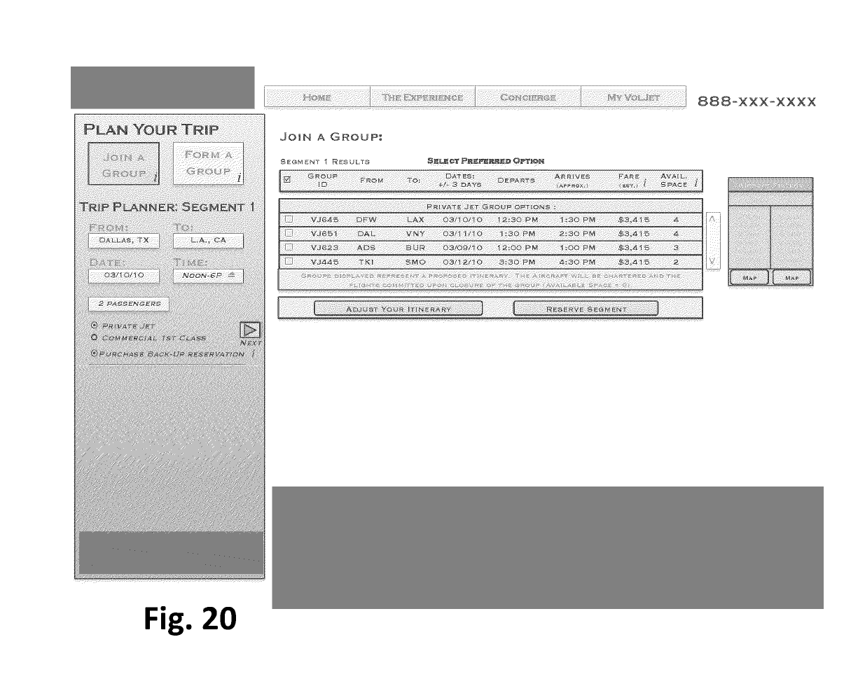

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION OF PREFERRED EMBODIMENTS

The following description is not to be taken in a limiting sense, but is made merely for the purpose of describing the general principles of exemplary embodiments. The scope of the embodiments should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention. In general, the system of the current invention provides a service to enable travelers to connect with other travelers who desire to travel on non-commercial, private air, water and/or ground travel means, e.g., private aircrafts, to the same destination, at the same time, at a significantly reduced rate of the full charter cost. Thus, the system provides for more accessible and affordable travel on private aircrafts. It is noted that throughout this description the terms private aircraft, non-commercial aircraft, and business jet aircraft are considered to mean any non-commercial aircraft.

According to one or more embodiments, an on-line interactive form is provided that can enable travelers to post city-pairs and departure times (e.g., a Form a Group feature) or to join an existing group posting (e.g., a Join a Group feature). The traveler can also charter a full jet and not share if desired. The system can search and retrieve group data, send out email alerts to customers who sign up for the “Who's Going” alert service, offers +/−3 day travel options, and can automatically close the Group once certain parameters are met. If no Group is available at the time of a group closure deadline, the system can optionally automatically connect to a commercial carrier option. The system can thus provide increased opportunities, convenience, efficiency and cost savings to premium travelers and the jet owners/operators.

Furthermore, according to several embodiments, advertised system prices can be all-inclusive of all fees with the exception of Federal Excise Tax, which is required to be separate. For ease of “real time” internet pricing for the traveler and jet operator profit predictability, in one embodiment, the system provides for a predetermined fill threshold to provide the set pricing. In one embodiment, the system bases the passenger fill factor threshold on a fixed-price that is pre-negotiated and pre-set with the jet operators by city pair and aircraft type.

In one embodiment, a set fee can be developed by the system based on a pricing model. For illustrative purposes only, the system pricing model can be based on a passenger threshold of roughly 50 percent of the aircraft load capacity. This can allow the highest level of passenger comfort and service. As demand for the system grows, the threshold can be adjusted by the system administrator based on a variety of factors to drive more revenue per jet and/or increase the demand for private jets that will drive recovery of the marketplace sector.

The present system could be developed to allow consumer use without the need for entry fees, deposit fees, or membership fees. In one embodiment, the system may charge a small per person transaction fee once a traveler has decided to “reserve” space in a system group, which would be in addition to their share of the group jet cost.

Online system architecture can be derived from established software platforms so long as desired system data flow is covered. Thus, the system can match travel preferences of multiple parties on a per-trip basis with an inventory of available business jets while charging no membership fees. This significantly reduces expense, simplifies the transaction, and improves “real time” accessibility of the service.

In one or more embodiments, the system can allow creation of groups of individuals to be presented to the charter operators for acceptance, such as Federal Aviation Administration (FAA), Part 135 certificated aircraft, while remaining in conformance with FAA and Department of Transportation (DOT) regulations. Additionally, the operators can review the closed group and offer the aircraft for that closed group even though the group may not be within a predetermined criteria for acceptance by the operator. In one or more embodiments, the system can also create an all-inclusive reservation method, which includes not only private, but also commercial, cargo, and other ground and water travel needs.

The present system provides several advantages. It can provide a matching methodology for travelers to meet through an organized on-line marketplace similar to popular social networking platforms, but organized specifically for premium travel. The present system can further provide for generating, maintaining and use of an inventory management system from the jet owners/operators perspective for commercial air travel that displays availability of business jets. This augments options to commercial air travel.

In one embodiment, the present system can combine the above-noted advantages and objectives to provide a new on-line reservation method and system that services business jet travel, commercial carrier travel, and may be expandable to all premium air (private, commercial, cargo, etc.), ground, and water travel needs. That is, in one embodiment, the system can create a database of available aircraft, similar in some aspects to those used in the commercial carrier industry, and matches the business jets to travelers on line. In one embodiment, the system can set and apply pre-negotiated rates with the operators to preclude the time consuming negotiation of a typical jet charter.

The present system can provide an on-line matching service bringing together operators of commuter and on demand aircrafts, such as FAA part 135 certificated business jets, with groups of travelers desiring to travel on these aircrafts. The service offers benefits to both parties not currently available to aircraft operators or the general public.

For example, in one embodiment, the system provides the ability for individual travelers to construct a travel itinerary including the ability to perform one or more functions to efficiently and effectively facilitate travel on a business jet. In one embodiment, the travelers can join an existing Group of travelers with similar needs to travel to a common destination on a specific date and time. In yet another embodiment, the system may create a new group and enable travelers to join a new group for travel to a common destination on a specific date and time, thereby allowing other travelers to aggregate into the Group and achieve the necessary minimum passenger threshold to commit the flight with an operator. In one or more embodiments, groups of travelers need to achieve a minimum passenger threshold before a flight can be committed and the itinerary for the travelers confirmed.

If the minimum passenger threshold is not met for any group, each traveler's booking fee and fare deposit can be automatically refunded. For travelers who elect to purchase an optional back-up reservation, their commercial air ticket purchase can be finalized and itinerary details forwarded to the traveler.

Alternatively, if the minimum passenger threshold is met, in one embodiment, the Group may then be presented to affiliated aircraft operators, e.g. FAA part 135 private jet operators. In one or more embodiments, once the group has reached the system internally designated threshold of group members, the group is then closed and the system acts on behalf of the customer to commit the appropriate aircraft, chosen from a network of participating FAA Part 135 operators.

Once the group is presented to the operators, according to some embodiments, the first operator to claim the Group can be awarded a charter contract for the carriage of the group. In one embodiment, the system may further allow operators to reserve travel groups in advance to achieving the minimum threshold. In such embodiments, once the threshold is reached, the operator having reserved the group can be awarded the charter contract for the carriage of the group. Once a contract is committed, no other travelers would be able to join the group. Also, once a contract is committed, the System may provide all travelers within the group at the time of commitment with various details about the aircraft operator along with information from the operator regarding where to report for the flight as well as all other logistical details relevant to their travel itinerary.

In an additional or alternative embodiment, the system can offer an opportunity to their customers to mix their private jet travel selection with a commercial carrier option for their travel segments, ensure they will not be without travel results and/or options. For example, in one embodiment, the system can further provide travelers with the option to purchase a back-up reservation on a commercial air carrier in case they require a higher level of certainty for their proposed itinerary and may further enable purchasing a traditional ticket for a seat on a commercial air carrier. In some embodiments, if the system determines that the private charter cannot be committed, the system may automatically purchase the backup itinerary for the passengers on the commercial air carrier.

In yet another embodiment, travelers can charter a private jet for their exclusive use at a flat rate without the need for an iterative negotiation process with a charter operator or a broker.

The system further provides operators with the opportunity to maximize profit and efficiency through increased utilization since a much larger customer base will be utilizing the system. Furthermore, by utilizing and optimizing existing assets, the matching system itself will not incur the high costs of owning and operating aircraft.

For example, in one embodiment, the system provides operators of commuter and/or private air carriers, e.g., FAA part 135 certificated aircraft, the ability to become affiliated with the service. Affiliation may be conditioned upon meeting requisite safety and certification standards and agreement to the system's terms of service. Affiliated operators aircraft can then be populated in the system's Inventory Management System database. The operator can also view open Groups that have not reached the closure threshold and select those groups to close at any time once posted. The Operators can also view the closed groups and offer their jet.

In one embodiment, the system can allow an affiliated Operator to post available aircraft within the system's inventory for prospective charters. In some instances, the Operators are further able to access and view traveler Groups and reserve specific groups they find suitable for their aircraft's flight operation. As described above, reserved Groups can automatically commit a charter reservation upon reaching the minimum passenger threshold for the group. In addition, Operators can optionally commit a charter contract on their available aircraft for a Group that has not yet achieved the minimum passenger threshold from their roster of reserved travelers groups and/or traveler groups reserved by other affiliated operators or not yet reserved.

Where Groups have achieved a predetermined minimum passenger threshold, the system can automatically assign the Group to an affiliated Operator available inventory of aircraft. This can occur when the system determines the Operator aircraft possesses, at a minimum, the predetermined itinerary and requirements. If a Group is Closed, but not selected by an Operator, the system can automatically match the Group with an appropriate and available aircraft upon confirmation from the operator. To encourage Operator participation, a fee may be optionally applied or waived to Operators to post aircraft inventory.

Accordingly, an automated model of the system of the present embodiments limits the number of decision variables, eliminates unnecessary negotiation steps and presents a decision and purchase process to the consumer in a familiar model similar to the models employed by commercial airlines. Additionally, the system can optionally support a combination of private jet and commercial airline travel into a single, unified purchase process. This can be achieved by the system by providing features including matching travelers with similar interests to for a specified time period to fly to common destinations, providing flat rate fares on non-commercial and private air, ground and water travel. Thus, this system can provide a completely on-line, user-focused, single point purchase experience. The service can optionally be offered with no membership fees, registration or login required to browse travel options.

Accordingly, the present system, in contrast to existing systems, offers the combination of private jet travel and commercial travel in one inclusive system. The system of the present invention may, in further embodiments, also offer a daily, weekly or monthly update to travelers summarizing open groups. In yet another embodiment, the system further provides additionally functionality such as airport filters to select optimized destinations and travel options, thus removing the burden of having to choose an aircraft type, simplifying the customer experience.

The present System's competitive advantage is in the adaptation and usage of a platform that is similar in certain aspects to the existing platforms that sell commercial airline tickets. This could provide a more familiar format, thus more desirable, to traveling consumers. Furthermore, advantages are provided since the matching system does not own or operate any aircraft assets but is leveraging an existing network of aircraft and operators. The system model, according to several embodiments, can accordingly focus primarily on forming the travel groups and bringing the people to planes versus planes to people. This type of system can allow several other indirect advantages such as improved overall fuel needed to move the traveling public since aircraft assets can be more efficiently operated with fewer empty seats on aircraft already scheduled to be in the air.

Turning now to the Figures, there is illustrated one embodiment, using the systems and methods of the presently described embodiments to arrange air travel using private (i.e., non-commercial) aircraft, and is generally indicated at 20.

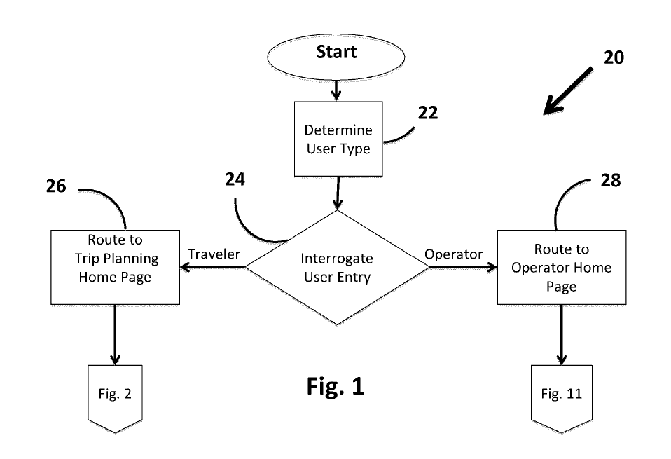

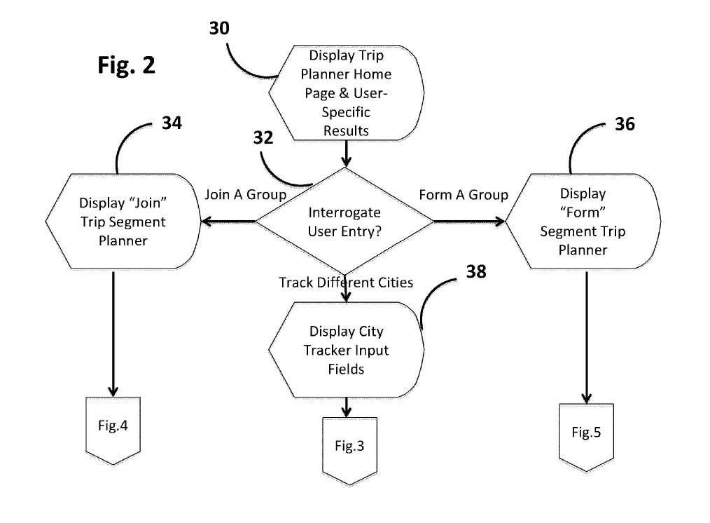

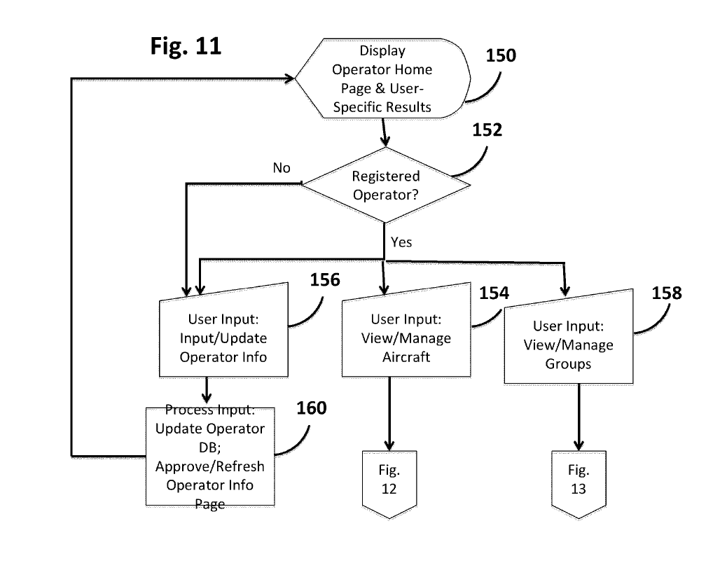

As shown in FIG. 1, on initiation of system 20, the system determines whether a user is a traveler or an operator at step 22. From step 22, the system requests the user make this indication at step 24. If the user indicates they are a traveler, the system moves to step 26 to route the user a Trip Planning Home Page (FIG. 2). The traveler can be registered. Accordingly, the system can load Traveler preferences as described below. If the user indicates they are an Operator, the system moves to step 28 to route the user to an Operator Home Page (FIG. 11). In describing the present system, the term Premium Traveler has been used. It is noted though that a Traveler can be anyone capable of legally scheduling and committing to online on-line air travel. Further, it is noted that an Operator can be anyone capable of legally committing a private aircraft and pre-approved by the system administrator.

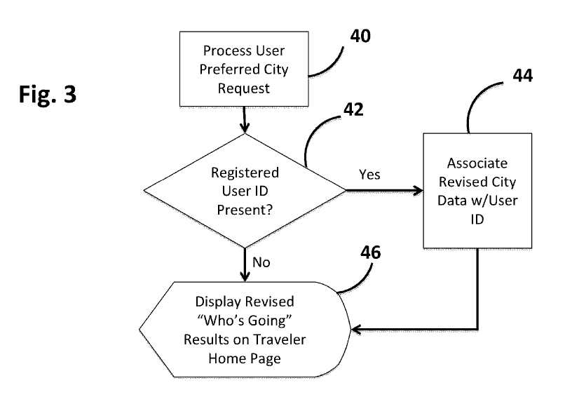

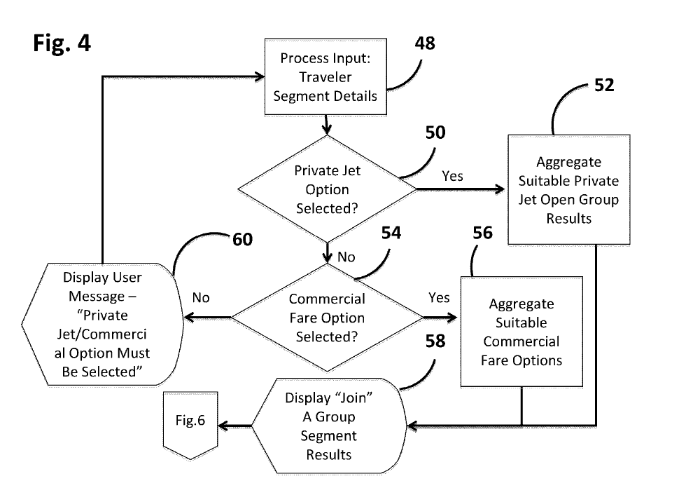

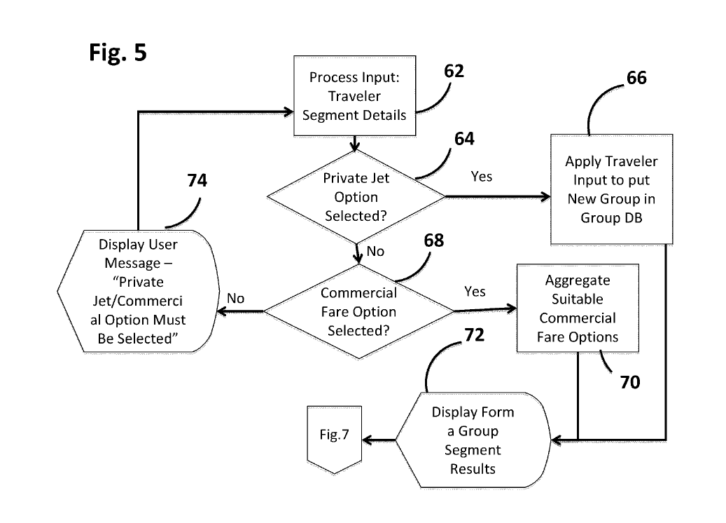

As shown in FIG. 2, a Trip Planning Home Page can be shown at step 30 and request a Traveler at step 32 to Join a Group, Form a Group, or Track a Destination (e.g., a city). If the traveler elects to join a Group, the system advances to step 34 to the “Join” trip segment planner (FIG. 4). If the traveler elects to Track a Destination, the system advances to step 38 to the “Display City Tracker” (FIG. 3). If the traveler elects to Form a Group, the system advances to step 36 to the “Form a Group” (FIG. 5).

Turning to FIG. 3, as indicated above, a destination tracker step 40 can process a destination request, such as a “Preferred City Request”. To do this, the system determines if the Traveler is a Registered User at step 42. If no, the system can return to step 26 at step 46 and input a “Who's Going” query on the Traveler home page to register. If yes at step 42, the system at step 44 can, through traveler input, associate and store a revised destination to the user's ID, then return to the Traveler Homepage at step 26.

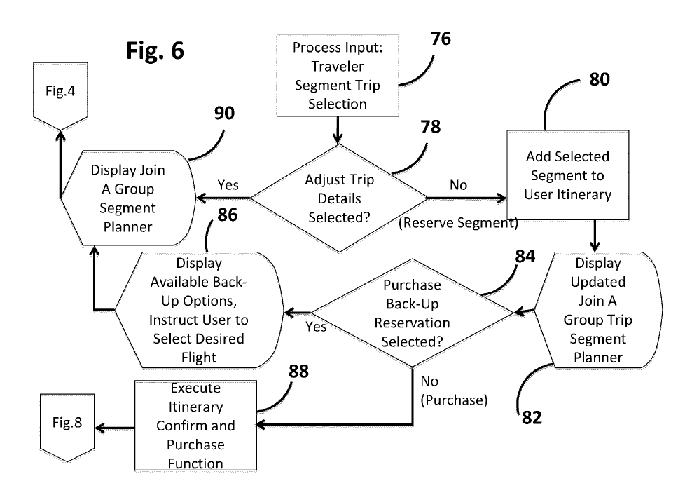

As shown in FIG. 4, at step 48 (from FIG. 2) the system can process user input on the Traveler's desired segment details. At step 50, the system can determine whether a private jet option has been selected. If no, the system can next determine at step 54 if a commercial fare option has been selected by the Traveler. If no at step 54, the system, at step 60, can display that a private and/or commercial option must be selected and return back to step 48. If yes at step 54, the system can aggregate suitable commercial fare options at step 56 and display segment results at step 58 and advance to the steps illustrated in FIG. 6. If at step 50 a private jet option is selected, the system can advance to step 52 to aggregate suitable private Open Groups, then proceed to step 58.

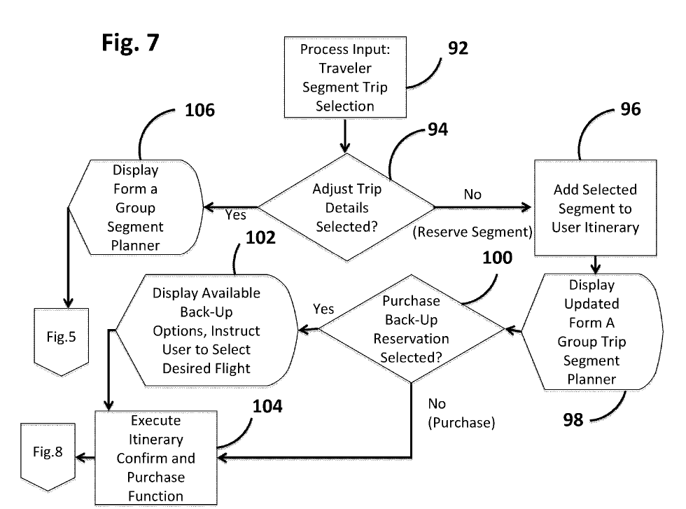

As shown in FIG. 5, at step 62 (from FIG. 2) the system can process user input on the Traveler's desired segment details. At step 64, the system can determine whether a private jet option has been selected. If no, the system can next determine at step 68 if a commercial fare option has selected by the Traveler. If no at step 68, the system, at step 74, can display that a private and/or commercial option must be selected and return back to step 62. If yes at step 68, the system can aggregate suitable commercial fare options at step 70 and display segment results at step 72 and advance to the steps illustrated in FIG. 7. If yes at step 64, the system can apply the traveler input to put the new group in the group database, then proceed to step 72.

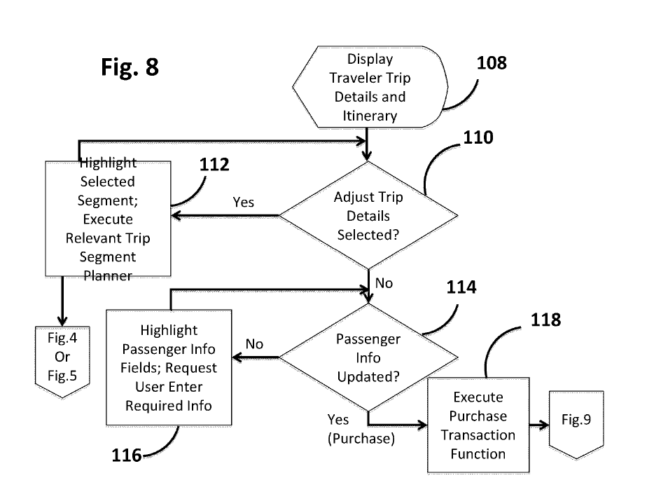

As shown in FIG. 6, at step 76 (from FIG. 4) the system can process user input on the Traveler's segment trip selection. At step 78, the system can determine whether the adjust trip details was selected. If yes, the system displays the join a group segment planner at step 90 and advances to the steps illustrated in FIG. 4. If no, the system can next determine at step 80 to add a selected segment to the user itinerary and display the updated join a group trip segment planner at step 82. At step 84, the system can determine whether the purchase back-up reservation was selected. If no at step 84, the system, at step 88, can process the execute itinerary, confirm and purchase function, and advances to steps illustrated in FIG. 8. If yes at step 84, the system at step 86 displays the available back-up options and instructs the user to select the desired flight then moves to step 90 where the join a group segment planner is displayed and advances to the steps illustrated in FIG. 4.

As shown in FIG. 7, at step 92 (from FIG. 5) the system can process user input on the Traveler's segment trip selection. At step 94, the system can determine whether the adjust trip details was selected. If yes, the system displays the form a group segment planner at step 106 and advances to the steps illustrated in FIG. 5. If no, the system can next determine at step 96 to add a selected segment to the user itinerary and display the updated form a group trip segment planner at step 98. At step 100, the system can determine whether the purchase back-up reservation was selected. If no at step 100, the system, at step 104, can process the execute itinerary, confirm and purchase function and advances to steps illustrated in FIG. 8. If yes at step 100, the system displays at step 102 the available back-up options and instructs the user to select the desired flight then moves to step 104 where the system executes the itinerary, confirm and purchase function, and advances to the steps illustrated in FIG. 8.

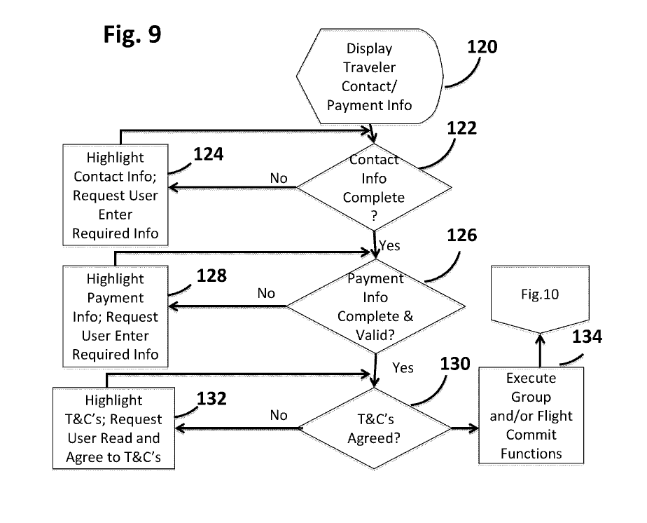

As shown in FIG. 8, at step 108 (from FIG. 7) the system displays the traveler's trip details and itinerary. At step 110, the system can determine whether the adjust trip details has been selected. If no, the system can next determine at step 114 if the passenger information was updated. If no at step 114, the system at step 116 highlights the passenger information fields and requests the user enter the required information. If yes at step 114, the system executes the purchase transaction function at step 118 and advances to the steps illustrated in FIG. 9. At step 110 if the adjust trip details is selected, the system can advance to step 112 to highlight the selected segment and executes the relevant trip segment planner and advances to the steps illustrated in FIG. 4 or FIG. 5.

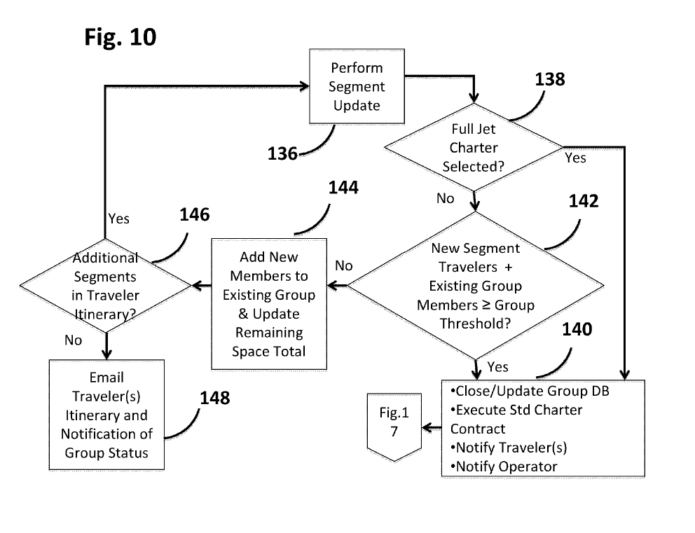

As shown in FIG. 9, at step 120 (from FIG. 8) the system displays the traveler's contact and payment information. At step 122, the system can determine whether the contact information is complete. If no, the system at step 124 highlights the contact information and requests the user to enter the required information and proceeds to step 122. If yes, the system can next determine at step 126 if the payment information is complete and valid. If no at step 126, the system, at step 128, highlights the payment information field and requests the user enter the required information and proceeds to step 126. If yes at step 126, the system at step 130 can determine if the terms and conditions have been agreed to. If yes at step 130, the system at step 134 executes the group and/or flight commit functions and advances to the steps illustrated in FIG. 10. If no at step 130 the system at step 132 highlights the terms and conditions and requests user to read and agree to the terms and conditions and proceeds to step 130.

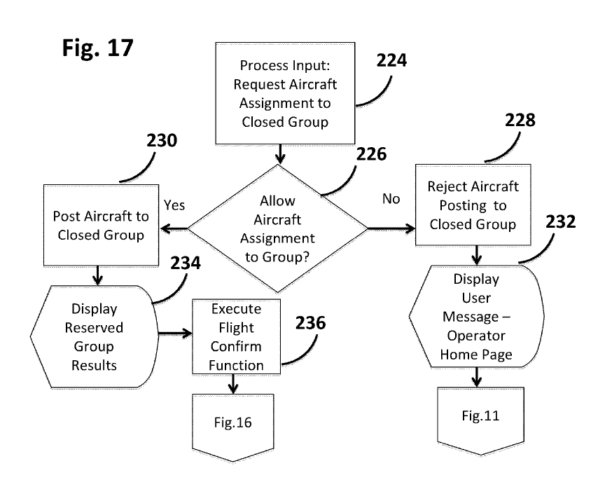

As shown in FIG. 10, at step 136 (from FIG. 9) the system can process the user input to perform the segment update. At step 138, the system can determine whether the full jet charter has been selected. If yes at step 138, the system at step 140 processes the user input and closes/updates the group database, executes the standard charter contract, notifies the traveler(s) and notifies the operator and advances to the steps illustrated in FIG. 17. If no, the system can next determine at step 142 if the new segment travelers plus the existing group members is a greater or equal to value than the group threshold. If yes at step 142, the system at step 140 processes the user input and closes/updates the group database, executes the standard charter contract, notifies the traveler(s) and notifies the operator. If no at step 142, the system, at step 144, can process the user input to add new members to the existing group and updates the remaining space total and proceeds to step 146. At step 146, the system can determine whether additional segments are selected in the traveler itinerary. If yes at step 146, the system processes the user input to perform the segment update at step 136. If no at step 146, the system at step 148 processes the user input to email the traveler(s) itinerary and notification of the group status.

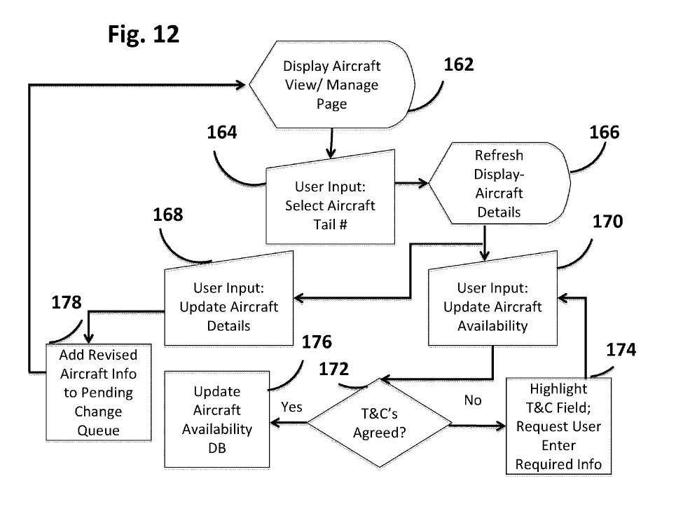

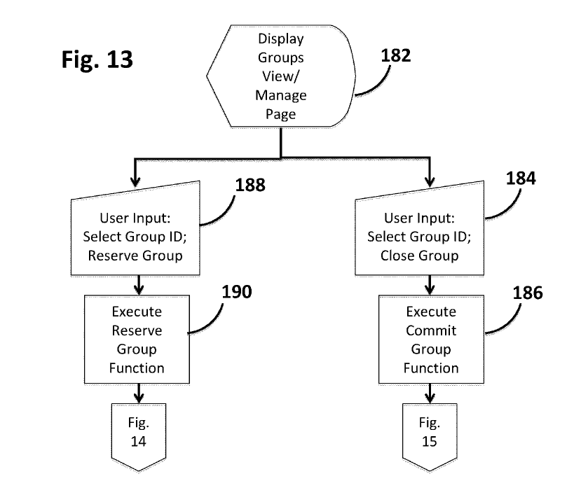

As shown in FIG. 11, at step 150 (from FIG. 1), the system displays the operator home page and user-specific results and at step 152, the system can determine whether the operator is registered. If no at step 152, the system proceeds to the manual function at step 156 and requests user to input/update operator information and proceeds to the process input step 160 for update of operator database and approval or refresh of the operator information page. After step 160, the system proceeds to step 150 where the operator home page and user specific results are displayed. If yes at step 152, the system proceeds to the functions requiring manual user inputs in steps 154, 156, and 158. Step 154 requests user input for the view/manage aircraft function and advances to the steps illustrated in FIG. 12. Step 156 requests user to input/update operator information and proceeds to the process input step 160 for update of operator database and approval or refresh of the operator information page and then proceeds to step 150 where the operator home page and user-specific results are displayed. Step 158 requests user input to update view/manage groups and advances to the steps illustrated in FIG. 13.

As shown in FIG. 12, at step 162 (from FIG. 11), the system displays the aircraft view/manage page and proceeds to step 164 that requests user input to select the aircraft tail number. Step 166 displays or refreshes the aircraft details and proceeds to step 168 that requests user input to update aircraft details and step 170 that requests user input to update the aircraft availability. Step 168 proceeds to step 178 where the system processes the user input adding the revised aircraft information to the pending change queue and proceeds to step 162, the display aircraft view/manage page. Step 170 proceeds to step 172 where the system can determine at step 172 whether the terms and conditions were agreed to. If yes at step 172, the system at step 176 processes the user input to update the aircraft availability database. If no at step 172, the system at step 174 processes the user input highlighting the terms and conditions field and requests user to enter the required information and returns to step 170 for user input to update aircraft availability.

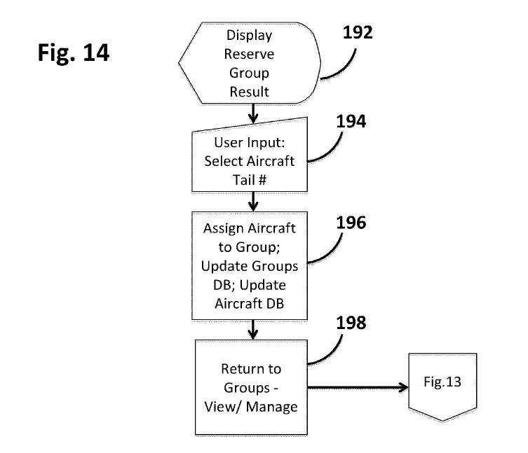

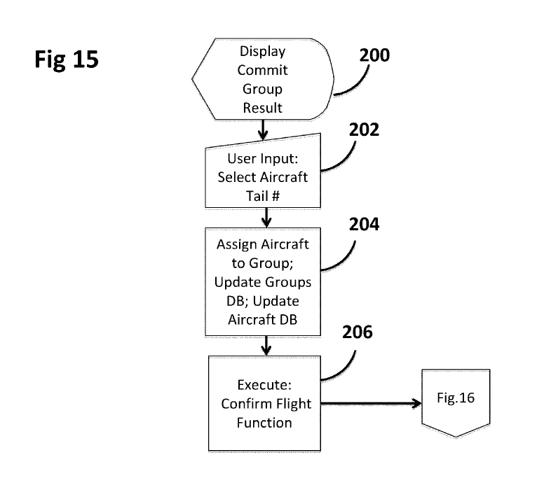

As shown in FIG. 13, at step 182 (from FIG. 11), the system displays the groups view/manage page and proceeds to the functions requiring manual user inputs in steps 184 and 188. Step 184 requests user input to select the group identification and close the group. Step 186 executes the commit group function and advances to the steps illustrated in FIG. 15. Step 188 requests user input to select the group identification and reserve the group. Step 190 executes the reserve group function and advances to the steps illustrated in FIG. 14.

As shown in FIG. 14, at step 192 (from FIG. 13), the system displays the reserve group results and proceeds to step 194 that requests user input to select the aircraft tail number. Step 196 processes the user input and assigns an aircraft to the group, updates the group database and updates the aircraft database. Step 198 processes the user input return to groups view/manage page and advances to the steps illustrated in FIG. 13.

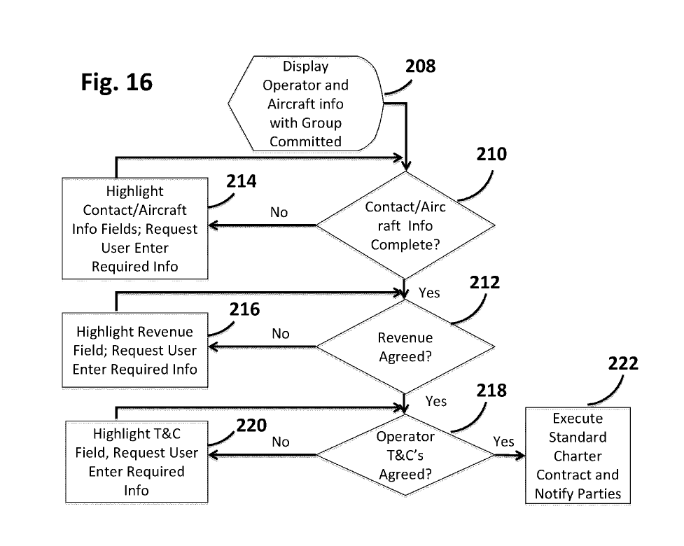

As shown in FIG. 15, at step 200 (from FIG. 13), the system displays the commit group results and proceeds to step 202 that requests user input to select the aircraft tail number. Step 204 processes the user input and assigns an aircraft to the group, updates the group database, and updates the aircraft database. Step 206 processes the user input return to execute the confirm flight function and advances to the steps illustrated in FIG. 16.

As shown in FIG. 16, at step 208 (from FIG. 15) the system displays the operator and aircraft information with the group committed. At step 210, the system can determine whether the contact/aircraft information is complete. If no, the system at step 214 highlights the contact/aircraft information fields and requests the user to enter the required information and proceeds to step 210. If yes, the system can next determine at step 212 if the revenue is agreed to. If no at step 212, the system at step 216 highlights the revenue field and requests the user to enter the required information and proceeds to step 212. If yes at step 212, the system at step 218 can determine if the terms and conditions have been agreed to. If yes at step 218, the system at step 222 executes the standard charter contract and notifies the parties. If no at step 218 the system at step 220 highlights the terms and conditions and requests the user to enter the required information and proceeds to step 218.

As shown in FIG. 17, at step 224 (from FIG. 10) the system can process user input on the request to assign an aircraft to a closed group. At step 226, the system can determine whether to allow the assignment of the aircraft to the group. If yes, the system posts the aircraft to the closed group at step 230 and displays the reserved group results in step 234. In step 236 the system executes the flight confirm function and advances to the steps illustrated in FIG. 16. If no in step 226, the system in step 228 rejects the aircraft posting to the closed group. Step 232 displays the user message operator home page and advances to steps illustrated in FIG. 11.

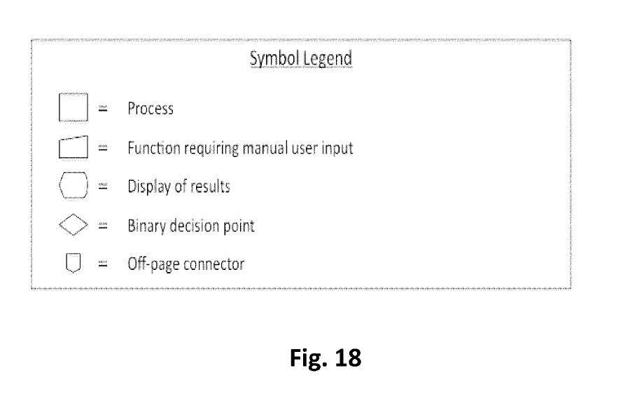

To assist in understanding the symbols utilized, FIG. 18 displays the legend and description of each symbol used in FIGS. 1-17.

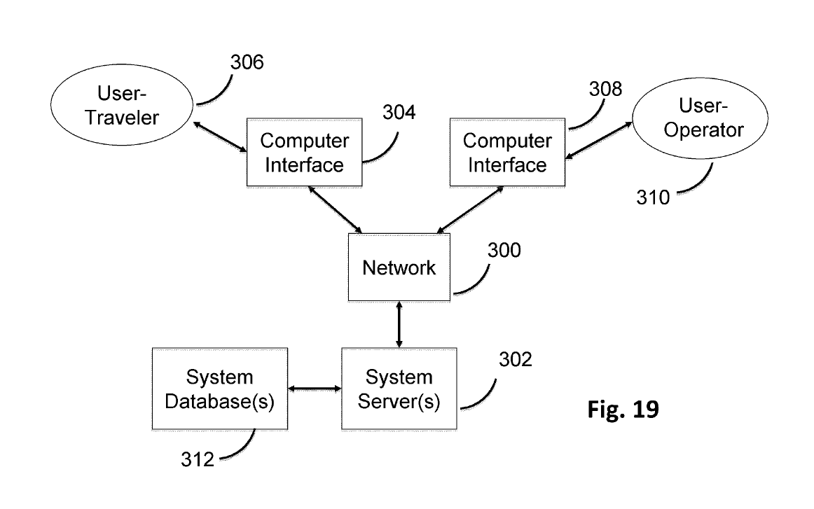

To assist in understanding the systems and methods of the present embodiments, FIG. 19 is a block diagram illustrating an exemplary network and component environment in which a system, according to the present embodiments, may be practiced. As is illustrated in FIG. 19, network 300, such as a private wide area network (WAN), local area network (LAN), and/or the Internet, can include a number of networked servers 302 that are accessible by client computers, for example Computer Interface 304 for Traveler 306 use and Computer Interface 308 for Operator 310 use. Communication between client computers and servers 302, which include system databases 312, can occur over a publicly accessible network, such as a public switched telephone network (PSTN), a DSL connection, a cable modem connection, or large bandwidth trunks (e.g., communications channels providing T1, T3, OC3 service, and the like), or wireless link. Or the system, in whole or in part, may only be accessible through a non-public accessible network to some or all client computers. Client computers may access servers 302 through, for example, a service provider. This might be, for example, an Internet Service Provider (ISP). Access is typically had by executing application-specific software (e.g., network connection software and a browser) on the given one of client computers.

One or more of client computers and/or one or more of servers may be, for example, a computer system of any appropriate design, in general, including a mainframe, a mini-computer, or a personal computer system which are known in the art (not shown). Such a computer system typically includes a system unit having a system processor and associated volatile and non-volatile memory, one or more display monitors and keyboards, one or more diskette drives, one or more fixed disk storage devices, and one or more printers. These computer systems are typically information handling systems which are designed to provide computing power to one or more users, either locally or remotely. Such a computer system may also include one or a plurality of I/O devices (i.e., peripheral devices) which are coupled to the system processor and which perform specialized functions. Examples of I/O devices include modems, sound and video devices, and specialized communication devices. Mass storage devices such as hard disks, CD-ROM drives, and magneto-optical drives may also be provided, either as an integrated or peripheral device.

Many devices or subsystems may be connected in a similar manner (e.g., bar code readers, document scanners, digital cameras, and so on). Conversely, it is not necessary for all of the devices to be present to practice the present embodiments. The devices and subsystems may also be interconnected in different ways. Code to implement the present invention may be stored in computer-readable storage media, such as one or more of system memory, fixed disk, CD-ROM, floppy disk, or other storage media know in the art. Additionally, the computer system may be any kind of computing device, and so includes personal data assistants (PDAs), cellular phones, smart phones, network appliances, or other such computing devices. The computer system can also support a number of Internet access tools including, for example, an HTTP-compliant web browser having a JavaScript interpreter.

The foregoing described embodiments and different components can be contained within different other components (e.g., the various elements shown as components of the computer system). It is to be understood that such depicted architectures are merely examples and that, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other, such that the desired functionality is achieved, irrespective of architectures or intermediate components. Likewise, any two components so associated can also be viewed as being “closely connected” or “closely coupled” to each other to achieve the desired functionality.

A browser running on a computer system can employ a TCP/IP connection to pass a request to server, which can run an HTTP “service” (e.g., under the WINDOWS® operating system) or a “daemon” (e.g., under the UNIX® operating system), for example. Such a request can be processed, for example, by contacting an HTTP server employing a protocol that can be used to communicate between the HTTP server and the client computer. The HTTP server then responds to the protocol, typically by sending a “web page” formatted as an HTML file. The browser interprets the HTML file and may form a visual representation of the same using local resources (e.g., fonts and colors).

While the invention herein disclosed has been described by means of specific embodiments, examples and applications thereof, numerous modifications and variations could be made thereto by those skilled in the art without departing from the scope of the invention set forth in the claims.

We claim:

1. A system to facilitate group travel on non-commercial aircraft, comprising:
an aircraft operator database on an electronic medium having a listing of registered, independent, and non-commercial aircraft;
the aircraft operator database further having a registry of non-commercial aircraft available to accept a group for an identified trip segment;
a grouping service having access to the aircraft operator database via a computer network that is able to provide formation of the group to travel and communicate the group to the aircraft operator; and
the grouping service is able to transmit a group acceptance of the group by the aircraft operator.

2. The system of claim 1, further comprising collection of payment from the group and transfer of payment to the aircraft operator.

3. The system of claim 1, wherein the formation of a group closes upon identification of predetermined minimum number of travelers on an identified trip segment.

4. The system of claim 3, wherein the closed group is transmitted to the aircraft operator automatically upon closure.

5. The system of claim 1, wherein the group is transmitted to the aircraft operator upon a request of an aircraft operator and the grouping service having identified at least one traveler for the at least one identified trip segment.

6. The system of claim 1, wherein identified trip segment information includes, airport of origin and destination, space availability, and an approximation of a departure and arrival time within a predetermined time variance.

7. The system of claim 1, further comprising a reservation service to a commercial carrier upon request by a traveler either when no availability is found in the aircraft operator database for a desired travel segment or upon request by the traveler.

8. The system of claim 1, wherein upon the grouping service can close a group, accept payment from travelers within the group, and transmit the group to the aircraft operator.
